(19) United States
(12) Patent Application Publication
(10) Pub. No.: US 2019/0392429 A1
(43) Pub. Date: Dec. 26, 2019

(54) CAPITAL INHERITANCE SYSTEM AND METHOD FOR FACILITATING TRANSFER OF DIGITAL CRYPTOCURRENCY

(71) Applicant: Innoplexus AG, Eschborn (DE)

(72) Inventors: Abhijit Keskar, Pune (IN); Akash Madan Mishra, Mumbra (IN)

(21) Appl. No.: 16/162,623

(22) Filed: Oct. 17, 2018

Related U.S. Application Data
(60) Provisional application No. 62/688,773, filed on Jun. 22, 2018.

(51) Int. Cl. G06Q 20/36; G06Q 50/18; H04L 9/06

(52) U.S. Cl. CPC G06Q 20/3674; H04L 9/0637; G06Q 50/186; G06Q 20/363

(57) ABSTRACT

Disclosed is a capital inheritance system, when in operation, facilitates a transfer of digital cryptocurrency from a first party to a second party. The system comprising a server arrangement, wherein the server arrangement receives from the first client device of the first party, details associated with the digital cryptocurrency, a validation condition, identification information related to the second party, adds a smart contract to a blockchain, wherein the smart contract comprises the validation condition and a validation indicator, activates a ledger clock for the smart contract, and enables the second party to retrieve the digital cryptocurrency, in response to an execution of the smart contract at a completion of a ledger clock cycle, wherein the execution of the smart contract is based on activation of the validation indicator.

### CROSS-REFERENCE TO RELATED APPLICATIONS

This is a non-provisional patent application based upon a provisional patent application No. 62/688,773 as filed on Jun. 22, 2018, and claims priority under 35 U.S.C. 199(e).

### TECHNICAL FIELD

The present disclosure relates generally to inheritance of digital capital; and more specifically, to cryptocurrency inheritance systems, that when operated, facilitate transfer of digital cryptocurrency from first party to second party. Furthermore, the present disclosure also relates to methods of facilitating transfer of digital cryptocurrency from first party to second party.

### BACKGROUND

In recent years, digital technology revolution has radically changed the business environment. Furthermore, digitization of capital has enabled storage of intangible digital cryptocurrencies in digital wallets. Moreover, such technologies related to the digital cryptocurrencies facilitate expeditious exchange of the digital cryptocurrencies from one user to another user using technologies such as smart phones, electronic cards, online digital-currency exchange, and so forth. Furthermore, digital cryptocurrencies have established gateway for virtual transactions.

However, storage of said digital cryptocurrencies in digital wallets associated therewith, for various business and commercial transactions, has raised concerns pertaining to inheritance of such digital wallets. An owner of the digital cryptocurrencies may secure the digital cryptocurrencies against unauthorized access by way of several security layers. Typically, such security layers are implemented by way of username, password, security question, and so forth. Conventionally, a legal will is prepared to transfer inheritance of tangible real capital (such as, tangible capital existing in form of notes, coins, property, and so forth) to a rightful heir of the owner. However, there exists no means to establish guidelines pertaining to the transfer of inheritance of the digital cryptocurrencies from the owner to the rightful heir. Subsequently, in unforeseeable conditions (such as, sudden demise of the owner), information pertaining to the security layers of the digital cryptocurrencies may not be provided to the heir. In such case, lack of the information pertaining to the security layers of the digital cryptocurrencies may lead to abandonment of the digital cryptocurrencies stored in the digital wallet. Moreover, the inheritance of said digital cryptocurrencies may not be transferred to the heir at a time, mandated by the owner. Subsequently, the heir or the owner may face difficulty due to delayed and troublesome process for transferring the digital cryptocurrencies. Additionally, the lack of established guidelines pertaining to the transfer of inheritance of the digital cryptocurrencies from the owner to the rightful heir may lead to conflicts and confusion.

Generally, the owner of the digital cryptocurrencies provides the information pertaining to the security layers of the digital cryptocurrencies to the rightful heir via direct communication. However, providing the information pertaining to the security layers of the digital cryptocurrencies enables the heir to access the digital cryptocurrencies immediately, upon receiving the information pertaining to the security layers of the digital wallet. In an example, the owner of digital cryptocurrencies may provide information pertaining to the security layers of the digital cryptocurrencies to the heir in faith. However, in such case, there is a risk of fraudulent and misuse of the provided information by the heir. Moreover, disclosing the information pertaining to the security layers of the digital cryptocurrencies through conventional methods may have associated risks such as access of such information by an unauthorized third party, false transfer of ownership, misuse of such information, security threats, and so forth.

Therefore, there is a need to overcome the aforementioned drawbacks associated with conventional methods of transferring inheritance of digital cryptocurrencies from an owner to an heir.

### SUMMARY

The present disclosure seeks to provide a capital inheritance system, that when operated, facilitates a transfer of digital cryptocurrency from a first party to a second party. The present disclosure also seeks to provide a method of facilitating a transfer of digital cryptocurrency from a first party to a second party. The present disclosure seeks to provide a solution to the existing problem of abandonment of the digital cryptocurrency and lack of reliable means for transferring the inheritance of the digital cryptocurrency from the first party to the second party. An aim of the present disclosure is to provide a solution that overcomes at least partially the problems encountered in prior art, and provides a reliable and secure platform that facilitates the transfer of the digital cryptocurrency from the first party to the second party.

In one aspect, an embodiment of the present disclosure provides a capital inheritance system, when in operation, facilitates a transfer of digital cryptocurrency from a first party to a second party, the capital inheritance system comprising a server arrangement communicably coupled via one or more communication networks with a first client device of the first party and with a second client device of the second party, wherein the server arrangement:
receives, from the first client device of the first party, details associated with the digital cryptocurrency, a validation condition, identification information related to the second party;
adds a smart contract to a blockchain, wherein the smart contract comprises the validation condition and a validation indicator, and wherein activation of the validation indicator in the smart contract indicates a satisfaction of the validation condition;
activates a ledger clock for the smart contract, wherein the ledger clock is configured to defer an execution of the smart contract to a next cycle of the ledger clock in response to absence of activation of the validation indicator in the smart contract; and
enables the second party to retrieve the digital cryptocurrency, in response to an execution of the smart contract at a completion of a ledger clock cycle, wherein the execution of the smart contract is based on activation of the validation indicator.

In another aspect, an embodiment of the present disclosure provides a method of facilitating a transfer of digital cryptocurrency from a first party to a second party, wherein the method is implemented via a capital inheritance system comprising a server arrangement communicably coupled via one or more communication networks with a first client device of the first party and with a second client device of the second party, the method comprising:
receiving, from the first client device of the first party, details associated with the digital cryptocurrency, a validation condition, identification information related to the second party;
adding a smart contract to a blockchain, wherein the smart contract comprises the validation condition and a validation indicator, and wherein activation of the validation indicator in the smart contract indicates a satisfaction of the validation condition;
activating a ledger clock for the smart contract, wherein the ledger clock is configured to defer an execution of the smart contract to a next cycle of the ledger clock in response to absence of activation of the validation indicator in the smart contract; and
enabling the second party to retrieve the digital cryptocurrency, in response to an execution of the smart contract at a completion of a ledger dock cycle, wherein the execution of the smart contract is based on activation of the validation indicator.

Embodiments of the present disclosure substantially eliminate or at least partially address the aforementioned problems in the prior art, and enables transfer of digital cryptocurrency from the first party to the second party securely with minimal human intervention at a time mandated by the first party or as per the guidelines defined by the first party.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a network environment, wherein a capital inheritance system for facilitating a transfer of digital cryptocurrency from a first party to a second party is implemented, pursuant to an embodiment of the present disclosure;

FIG. 2 is a schematic illustration of a high-level architecture of a network environment in which a capital inheritance system for facilitating a transfer of digital cryptocurrency from a first party to a second party is implemented, pursuant to a specific embodiment of the present disclosure;

FIG. 3 is a flow chart depicting steps of a method of facilitating a transfer of digital cryptocurrency from a first party to a second party, in accordance with an embodiment of the present disclosure;

FIGS. 4A, 4B, 4C and 4D are example views of a user interface of a capital inheritance system presented on a graphical user interface of a first client device of a first party, in accordance with an embodiment of the present disclosure; and

FIG. 5 is an example view of a user interface of a capital inheritance system to provide proof of occurrence related to a validation condition, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a capital inheritance system, when in operation, facilitates a transfer of digital cryptocurrency from a first party to a second party, the capital inheritance system comprising a server arrangement communicably coupled via one or more communication networks with a first client device of the first party and with a second client device of the second party, wherein the server arrangement:
receives, from the first client device of the first party, details associated with the digital cryptocurrency, a validation condition, identification information related to the second party;
adds a smart contract to a blockchain, wherein the smart contract comprises the validation condition and a validation indicator, and wherein activation of the validation indicator in the smart contract indicates a satisfaction of the validation condition;
activates a ledger clock for the smart contract, wherein the ledger clock is configured to defer an execution of the smart contract to a next cycle of the ledger clock in response to absence of activation of the validation indicator in the smart contract; and
enables the second party to retrieve the digital cryptocurrency, in response to an execution of the smart contract at a completion of a ledger clock cycle, wherein the execution of the smart contract is based on activation of the validation indicator.

In another aspect, an embodiment of the present disclosure provides a method of facilitating a transfer of digital cryptocurrency from a first party to a second party, wherein the method is implemented via a capital inheritance system comprising a server arrangement communicably coupled via one or more communication networks with a first client device of the first party and with a second client device of the second party, the method comprising:
receiving, from the first client device of the first party, details associated with the digital cryptocurrency, a validation condition, identification information related to the second party;
adding a smart contract to a blockchain, wherein the smart contract comprises the validation condition and a validation indicator, and wherein activation of the validation indicator in the smart contract indicates a satisfaction of the validation condition;
activating a ledger clock for the smart contract, wherein the ledger clock is configured to defer an execution of the smart contract to a next cycle of the ledger clock in response to absence of activation of the validation indicator in the smart contract; and
enabling the second party to retrieve the digital cryptocurrency, in response to an execution of the smart contract at a completion of a ledger clock cycle, wherein the execution of the smart contract is based on activation of the validation indicator.

The present disclosure provides the aforesaid capital inheritance system and the aforesaid method of transferring inheritance of the digital cryptocurrency from the first party to the second party. Beneficially, the system and the method described herein provides a platform to facilitate the transfer of the digital cryptocurrency from the first party to the second party. The system and the method disclosed herein enables the first party to establish a set of guidelines pertaining to the transfer of the digital cryptocurrency.

Furthermore, the aforesaid capital inheritance system operates in secure and reliable manner, to transfer the inheritance of digital cryptocurrency from the first party to the second party. The aforesaid system and the aforesaid method facilitates the transfer of inheritance of the digital cryptocurrency of the first party to the second party upon fulfilment of a condition in real life such as, for example, death of the first party (namely, owner of the digital cryptocurrency), obtaining an educational qualification by the second party (namely, an intended heir of the digital cryptocurrency) and so forth. Moreover, the system described herein operates automatically and with minimal human intervention upon the occurrence an unforeseeable event such as death of the first party, thereby preventing abandonment of the said digital cryptocurrency. Additionally, the aforesaid system minimizes the risk of errors and fallacy.

The aforesaid system enables the second party to access digital cryptocurrency associated with the first party upon completion of real-life conditions defined by the established set of guidelines pertaining to the transfer of said digital cryptocurrency. Consequently, the second party is granted access to the digital cryptocurrency of the first party only at a time approved by the first party. Moreover, the aforementioned system and the aforementioned method generates a smart contract that enables transparent and methodical transfer of the digital cryptocurrency from the first party to the second party. The details of transactions associated with the transfer of the digital cryptocurrency from the first party to the second party are stored in a blockchain. Subsequently, the information stored in the blockchain provides an immutable proof for the transaction thereby preventing fraudulent cases.

It will be appreciated that the capital inheritance system proffers a platform to achieve a technical effect of enabling methodical and transparent transfer of the digital cryptocurrency from the first party to the second party. Moreover, the aforesaid system prevents loss or abandonment of digital cryptocurrency thereby preventing any financial risk or uncertainty associated with the digital cryptocurrency. Consequently, a technical effect can be achieved on real life contingencies by addressing financial losses. Additionally, the system and method described herein enhances the operational characteristics of a computer. It will be appreciated that the system addresses a crucial drawback associated with the digital cryptocurrency and the use thereof by providing the aforesaid platform for overcoming the security threats associated with the transferal of the inheritance of the digital cryptocurrency. Furthermore, the use of the blockchain to implement the capital inheritance system provides greater transparency, enhanced security, improved traceability, increased efficiency and speed of transactions.

The capital inheritance system facilitates the transfer of the digital cryptocurrency from the first party to the second party. The capital inheritance system enables the first party to create a user account and store information pertaining to the one or more digital assets, which can later be accessed to facilitate the transfer of said one or more digital assets from the first party to the second party.

It will be appreciated that the aforesaid system and the aforesaid method are not limited to facilitating the transfer of the digital cryptocurrency from the first party to only a singular second party. The system and method enable the first party to designate a plurality of second parties. Subsequently, the system and the method can be employed to facilitate the transfer of the digital cryptocurrency from the first party to the designated plurality of second parties. Typically, the first party defines a share associated with the digital cryptocurrency for the transfer thereof, amongst the plurality of second parties.

It will be appreciated that the terms “first” “second” and the like herein do not denote any specific role or order or importance, but rather are used to distinguish one party from another. In other words, the first party and the second party can act as a transmitting party and a receiving party, respectively, at a given point of time, and can act as a receiving party and a transmitting party, respectively, at another point of time.

Throughout the present disclosure, the term “digital cryptocurrency” refers to a form of intangible personal property. In other words, the digital cryptocurrency can be referred to digital entities having associated monetary value, wherein the digital entities exist only in intangible electronic form. Furthermore, the digital cryptocurrency can be transferred between two parties with the help of technology such as computers, smart phones, laptops, and so forth. Optionally, the digital cryptocurrency can be employed to acquire (namely, purchase) goods and services. It will be appreciated that the digital cryptocurrency can be used as an alternate to tangible money for purchasing goods and services.

In an embodiment, the digital cryptocurrency may be regulated by a centralized authority. In such case, the central authority may control the flow and the supply of the digital cryptocurrency. In another embodiment, the digital cryptocurrency may be decentralized. In such case, various sources (such as, an issuer, a developer, a user, and so forth) may have control over the digital cryptocurrency. It will be appreciated that the digital cryptocurrency are digital currencies, wherein the digital currencies are money balance recorded electronically in an electronic data bank associated therewith. In such case, the electronic data bank associated with the digital currencies may be digital wallets, digital value cards, and so forth. Moreover, digital cryptocurrency can be employed to acquire goods and services such as a gaming application, a social network profile, and so forth. Examples of digital cryptocurrency include, but are not limited to, Bitcoin®, Ethereum®, Litecoin®, Ripple®, and so forth. Furthermore, the digital cryptocurrency can also include a group of electronic data bank (such as a group of digital wallets), wherein a plurality of the electronic data banks may comprise a combination of several types of abovementioned digital cryptocurrencies. Optionally, the plurality of the electronic data banks may or may not be linked to each other.

Specifically, the digital cryptocurrencies are decentralized digital currencies that employ cryptography to concatenate transactions associated therewith. More specifically, the digital cryptocurrencies utilize a proof-of-work and/or a proof-of-stake for managing transactions associated therewith. Moreover, it will be appreciated that the digital cryptocurrencies are virtual currencies. Typically, digital cryptocurrencies have a specified unit of value associated therewith. Beneficially, the digital cryptocurrency enables borderless and instantaneous transfer of the currencies. Moreover, the digital cryptocurrency eliminates the need of intermediate party for the transaction of the digital cryptocurrency between two parties.

Throughout the present disclosure, the terms “first party” and “second party” refer to a first user and a second user respectively, who acts as clients to the server arrangement in a client/server relationship. The first party and the second party can be any entity including a person (i.e., human being) or a virtual personal assistant (an autonomous program or a bot) using the system and method described herein.

It will be appreciated that the digital cryptocurrency may have been provided by an owner. The first party can be the owner of the digital cryptocurrency or a representative of the owner of the digital cryptocurrency, who uses the aforesaid capital inheritance system to facilitate the transfer of the digital cryptocurrency to the second party. Notably, the first party is intended to provide the digital cryptocurrency, or the details associated with the digital cryptocurrency, to the server arrangement for processing thereof. Additionally, the first party is intended to nominate the second party. Moreover, the second party can be, for example, an individual, who is a rightful heir of the digital cryptocurrency provided by the first party for transfer thereof, or a representative of an individual, who is a rightful heir of the digital cryptocurrency. The system and method described herein facilitates the transfer of the digital cryptocurrency from the first party to the second party.

In an exemplary embodiment, the first party may be presented with the platform (namely, the capital inheritance system) that facilitates the transfer of said digital cryptocurrency from the first party to the second party upon a graphical user interface, via the first client device. The graphical user interface allows the first party to provide (namely, input) information required to facilitate the transfer of inheritance from the first party to the second party. Optionally, the platform is implemented by way of a trusted software application that, when executed at the first client device, obtains the details associated with the digital cryptocurrency, the validation condition, the identification information related to the second party, the identification information related to the first party, and so forth. Optionally, in such a case, the trusted software application is received (for example, downloaded) from the server arrangement or a trusted third party. The trusted third party can be a publicly-accessible digital distribution platform, for example, such as Google Play®, the App Store® (for iOS®) and the like.

In an embodiment, the first party may provide digital cryptocurrency to the server arrangement. In a first example, the first party may upload the digital cryptocurrency such as Bitcoin Litecoin®, Ethereum®, Ripple® and so forth on the server arrangement by employing the first client device. In another embodiment, the first party may provide an information such as a link, a username, a security pin, a security password, and so forth associated with an electronic data bank storing the digital cryptocurrency, for access thereof. In a second example, the first party may provide a link associated with a digital wallet for accessing the digital cryptocurrency of the first party. In a third example, the first party may provide a username and a security pin for accessing the digital wallet storing the digital currencies.

The capital inheritance system comprises a server arrangement. Throughout the present disclosure, the term “server arrangement” refers to an arrangement of one or more servers that includes one or more processors configured to perform various operations, for example, as mentioned earlier. Optionally, the server arrangement includes any arrangement of physical or virtual computational entities capable of performing the various operations. The term “one or more processors” may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system.

Moreover, it will be appreciated that the server arrangement can be implemented by way of a single hardware server. The server arrangement can alternatively be implemented by way of a plurality of hardware servers operating in a parallel or distributed architecture. As an example, the server arrangement may include components such as a memory unit, a processor, a network adapter and the like, to store and process information pertaining to the document and to communicate the processed information to other computing components, for example, such as a client device. Furthermore, the server arrangement comprises a database arrangement for storing data therein.

Throughout the present disclosure, the term “server” generally refers to a device executing an application, program, or process in a client/server relationship that responds to requests for information or services by another application, program, process or device (namely, a client) on a data communication network. Optionally, a given server is implemented by way of a device executing a computer program that provides various services (for example, such as a database service) to other devices, modules or apparatus.

The term “client device” generally refers to a device executing an application, program, or process in a client/server relationship that requests information or services from another application, program, process or device (namely, a server) on a data communication network. Importantly, the terms “client” and “server” are relative, as an application may be a client to one application but a server to another application. Moreover, the client device can be electronic device associated with (or used by) a user (namely, a first party and a second party), that is capable of enabling the user to perform specific tasks associated with the aforementioned system/method. Furthermore, the client device is intended to be broadly interpreted to include any electronic device that may be used for voice and/or data communication over a wireless communication network.

Examples of the first and second client devices include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, a server, and Network-Attached Storage (NAS) devices.

Notably, the first and second client devices are configured to function as a “client” in a client/server relationship with the server arrangement. However, the first and second client devices may be configured to function as a “server” in a client/server relationship with other computing devices. Throughout the present disclosure, the terms “first client device” and “second client device” refer to devices associated with a first user and a second user that acts as clients to the server arrangement in a client/server relationship, wherein such devices can be personal devices or servers in local environments of the first user and the second user, respectively. As an example, the first client device can be an internal server of an owner of the digital cryptocurrency (namely, the first party), while the second client device can be an internal server of an individual to whom the said digital cryptocurrency is to be transferred (namely, the second party).

The server arrangement is communicably coupled via one or more communication networks with the first client device of the first party and with the second client device of the second party. The term “one or more communication networks” can be a collection of individual networks, interconnected with each other and functioning as a single large network. Such individual networks may be wired, wireless, or a combination thereof.

Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAX) networks.

The server arrangement receives, from the first client device of the first party, details associated with the digital cryptocurrency, a validation condition, identification information related to the second party. In other words, the server arrangement receives aforementioned attributes (namely, the details associated with the digital cryptocurrency, the validation condition, and the identification information related to the second party) pertaining to the transfer of the digital cryptocurrency, from the first party via the first client device (or a first server). The server arrangement is configured to present to the first party, a graphical user interface, via the first client device of the first party, that allows the first party to input the aforementioned attributes. It will be appreciated that the aforementioned attributes may be provided by the first party at a time of creation of user account or thereafter. In an embodiment, the server arrangement may present a questionnaire on the graphical user interface of the first client device (or the first server) of the first party.

Optionally, the details associated with the digital cryptocurrency comprises at least one of: a type of the digital cryptocurrency, a valuation associated with the digital cryptocurrency, a security pin for accessing the digital cryptocurrency, details required for accessing the digital cryptocurrency and a location of the digital cryptocurrency. Notably, the digital cryptocurrency may be in form of, but not limited to, Bitcoin cash®, Litecoin®, Ethereum®, and so forth, as mentioned earlier. Moreover, the valuation associated with the digital cryptocurrency can be a summation of monetary value or monetary worth of the digital cryptocurrency. Furthermore, the security pin for accessing the digital cryptocurrency can be a set of numeric values, a set of alphabets, or a combination thereof that is employed to access the digital cryptocurrency. In an example, the security pin may be a 4-digit numeric pin for a digital wallet containing the digital cryptocurrency. Moreover, the details required for accessing the digital cryptocurrency includes a username for accessing the digital wallet, a password for accessing the digital wallet, and so forth. Additionally, the location of the digital cryptocurrency may be an address of the digital cryptocurrency, where the digital cryptocurrency is stored. In an example, the location of the digital cryptocurrency may be provided by a hyperlink pointing to a database, wherein the digital wallet comprising the digital cryptocurrencies is stored.

Furthermore, optionally, the term “validation condition” refers to a real-time condition based on circumstances or factors, that affect the procedure of the transfer of the inheritance of the digital cryptocurrency from the first party to the second party. In other words, the validation condition is a criterion defined by the first party, that when fulfilled, enables the server arrangement to execute the transfer of the digital cryptocurrency from the first party to the second party. It will be appreciated that the first party may provide a plurality of validation conditions. In an example, the validation condition defined by the first party may be demise of the first party. In another example, the validation condition defined by the first party may be associated with an age of the second party such as reaching eighteen years of age. In yet another example, the validation condition defined by the first party may be associated with an educational qualification of the second party such as upon obtaining a graduation degree by the second party.

Optionally, the identification information related to the second party comprise at least one of: a name, a country, an e-mail address, a social security number, details pertaining to a digital wallet and a relation of the second party with the first party. The e-mail address refers to an electronic mailing address associated with the second party. Additionally, the social security number refers to a unique identification number associated with the second party. Optionally, the social security number may be a unique identification number associated with a digital wallet of the second party. The details pertaining to the digital wallet of the second party includes information such as a username, a password, a unique identification number associated with the digital wallet of the second party, an address of the digital wallet, and so forth.

In an example, the name of the second party may be ‘Alice’, the country of the second party may be ‘Canada’, the e-mail address of the second party may be ‘Alice@xyz.com’, the social security number of the second party may be ‘123456789’, the details pertaining to the digital wallet may include a unique number ‘1012345002’ for the digital wallet of the second party, and the relation of the second party with the first party may be ‘spouse’. In another example, the name of the second party may be ‘Bob’, the country of the second party may be ‘China’, the e-mail address of the second party may be ‘Bob@abc.com’, the social security number of the second party may be ‘987654321’, the details pertaining to the digital wallet may include a username ‘pay_bob’ for the digital wallet of the second party, and the relation of the second party with the first party may be ‘son’. Beneficially, the identification information related to the second party, provided by the first party can be employed to validate identity of the second party while transferring the digital cryptocurrency, thereby preventing any confusion and risks pertaining to identity theft.

Optionally, the server arrangement may store a plurality of information such as the details associated with the digital cryptocurrency, the validation condition, the identification information related to the second party and/or the identification information related to the first party. Pursuant to embodiments of the present disclosure, the server arrangement of the aforesaid system may store the plurality of information locally or in a database arrangement associated with the server arrangement. Optionally, the database arrangement comprises one or more databases. The database arrangement includes any data storage software and systems, such as, for example, a relational database like IBM DB2, Oracle 9, and so forth.

Optionally, in an instance, there can be a plurality of second parties. Subsequently, in such case, the server arrangement is configured to receive a distribution terms from the first party. Notably, the term “distribution terms” refers to conditions or clauses defined by the first party to quantify a distribution of digital cryptocurrency amongst the plurality of second parties. In an embodiment, the digital cryptocurrency owned by the first party may include digital currencies stored in a digital wallet. In an example, the first party may divide the digital currencies equally (such that each of the plurality of second parties get an equal share of the digital currencies) amongst the plurality of second parties. In another example, the first party may assign a certain percentage of the digital currencies for each of the plurality of second parties. In another embodiment, the digital cryptocurrency owned by the first party may be in form of a plurality of digital wallets stored at different locations. In such case, the first party may assign a particular digital wallet from amongst the plurality of digital wallets to each of the second party from amongst the plurality of second parties.

Optionally, the capital inheritance system provided by the server arrangement for the transfer of inheritance of digital cryptocurrency from the first party to the second party may have a characteristic cryptocurrency, associated therewith. The characteristic cryptocurrency is issued by the capital inheritance system. Moreover, the capital inheritance system controls the flow and supply of the characteristic cryptocurrency. Furthermore, in an example, the first party may purchase the characteristic cryptocurrency provided by the capital inheritance system and store thereto in a digital wallet. In such case, the capital inheritance system may directly enable the transfer of the characteristic cryptocurrency from the first party to the second party and store thereto in a digital wallet.

More optionally, the capital inheritance system may regulate an exchange rate for conversion of the digital cryptocurrency into the characteristic cryptocurrency. In an embodiment, the first party may provide the details associated with the digital cryptocurrency owned by the first party (such as, a username, a password, and so forth), to the capital inheritance system, for accessing the digital cryptocurrency such as Bitcoin cash®, Litecoin®, Ethereum®, Ripple®, and so forth stored in a blockchain. Furthermore, in another embodiment, the first party may provide the digital cryptocurrency such as Bitcoin®, Litecoin®, Ethereum®, Ripple®, and so forth stored in the blockchain, directly to the capital inheritance system. In such case, the capital inheritance system may access the digital wallet of the first party so as to convert the digital cryptocurrency such as Bitcoin®, Litecoin®, Ethereum®, Ripple®, and so forth stored in the blockchain, to the characteristic cryptocurrency, based on the exchange rate. Furthermore, the capital inheritance system enables the first party to convert a plurality of digital cryptocurrency, stored in various blockchains to a singular set of characteristic cryptocurrencies. Moreover, the first party may store the characteristic cryptocurrency in electronic data banks (namely, digital wallets) on a characteristic blockchain associated with the capital inheritance system.

The server arrangement adds the smart contract to the blockchain, wherein the smart contract comprises the validation condition and the validation indicator, and wherein activation of the validation indicator in the smart contract indicates a satisfaction of the validation condition. Throughout the present disclosure, the term “smart contract” refers to a document comprising a plurality of terms and conditions pertaining to a consensus, wherein the consensus is established between the first party and the second party regarding the transfer of the digital cryptocurrency. Moreover, the smart contract permits trusted execution of the consensus between the first party and the second party, without involving a central authority, legal system, or externally enforced mechanisms. The smart contract defines the plurality of terms and conditions pertaining to the consensus based upon the validation conditions, that enables the execution of the consensus in a traceable, transparent and irreversible manner.

Notably, the blockchain stores a plurality of blocks. More specifically, in the blockchain, each block stores a cryptographic hash of a previous block, new information stored in the block and a timestamp associated with the block. The plurality of terms and conditions pertaining to the consensus of the smart contract may be written in form of codes or algorithms. Pursuant to embodiments of the present disclosure, the smart contract is added to a block in the blockchain as new information stored in the block. Furthermore, the blockchain is managed by a peer-to-peer network collectively adhering to a protocol for inter-block communication and validating new blocks in a blockchain. Moreover, once a block is stored in the blockchain the block cannot be altered. Thus, storing the smart contract in the blockchain provides an immutable block comprising the consensus pertaining to the smart contract with its associated timestamp.

Optionally, the smart contract comprises at least one of: a contract for the undertaking of the digital cryptocurrency, an identification information related to the first party, an identification information related to the second party, and a proof of witness. The smart contract is generated by the server arrangement by employing the blockchain. The validation condition received by the server arrangement is embodied as terms and conditions of the smart contract. Furthermore, the blockchain prevents any one party from controlling or altering the smart contract. Subsequently, the smart contract is executed only when the validation condition defined by the first party, in the smart contract is satisfied

Furthermore, optionally, the blockchain platform is managed by a peer-to-peer network collectively adhering to a protocol for inter-block communication and validating new block in a blockchain. Moreover, once a block is stored in the blockchain, the block cannot be altered. Thus, storing the smart contract block in the blockchain provides an immutable block comprising the consensus pertaining to the smart contract with its associated timestamp.

The smart contract comprises the validation indicator, wherein the validation indicator is activated upon satisfaction of the transferal condition. Typically, the validation indicator is implemented by way of a set of codes and/or a set of algorithms. In an embodiment, the validation indicator is implemented by way of a flag function.

Optionally, the validation condition is satisfied upon receiving proof of occurrence relating to the validation condition. The term “proof of occurrence” refers to a document or a data that verifies the completion of the validation condition. In other words, the proof of occurrence refers to a document or a data that certifies the fulfilment of the validation condition. In an example, the validation condition may be death of the first party. In such example, the proof of occurrence may be a death certificate of the first party. In another example, the validation condition may be, acquiring a graduation level of educational qualification by the second party. In such example, the proof of occurrence may be a graduation degree of the second party obtained from an institution.

More optionally, the server arrangement may receive the proof of occurrence via a plurality of sources. Moreover, for example, the plurality of sources providing the proof of occurrence may be the second party, a government body, an event occurrence submit console or a third party, wherein the third party is an unknown party (namely, user).

Furthermore, optionally, the server arrangement authenticates the proof of occurrence relating to the validation condition. The validation condition is fulfilled upon the successful authentication of the proof of occurrence. Specifically, the server arrangement determines the authenticity of the proof of occurrence related to the validation condition, provided by the plurality of sources. More specifically, the server arrangement may communicate with a central regulatory or a central authority, to authenticate the proof of occurrence. In an example, the proof of occurrence may be a death certificate of the first party. In such example, the server arrangement may communicate with a government registrar to authenticate the legitimacy of the death certificate of the first party. In another example, the proof of occurrence may be a graduation degree of the second party that is issued by an institution. In such example, the server arrangement may communicate with the institution to authenticate the legitimacy of the graduation degree of the second party. Furthermore, upon successful authentication of the proof of occurrence, the validation condition is fulfilled. Specifically, the server arrangement validates the fulfilment of the validation condition upon successful authentication of the proof of occurrence.

Optionally, the server arrangement further stores a validation block on the blockchain upon successful authentication of the proof of occurrence relating to the validation condition. In other words, a validation block is added upon the fulfilment of the validation condition, to the blockchain. Optionally, the validation block added to the blockchain may be in communication with the smart contract block. It is to be understood that the validation block refers to a block comprising the proof of occurrence relating to the validation condition. In an embodiment, the block comprising the proof of occurrence relating to the validation condition (namely, the validation block) may also comprise information unrelated to the transferal condition.

Optionally, the server arrangement stores a metafile block on the blockchain, wherein the metafile block comprises information extracted from the proof of occurrence. Specifically, the server arrangement identifies important and specific data and credentials associated with the proof of occurrence. More specifically, the server arrangement extracts the important and specific data and credentials from the proof of occurrence and stores thereto in the metafile block. Typically, such important and specific data and credentials associated with the proof of occurrence constitutes the metafile. In an example, the proof of occurrence may be a death certificate of the first party. In such example, the server arrangement may extract at least one of: a serial number associated with the death certificate, an organizational body issuing the death certificate, and information pertaining to the death of the first party such as a date, a time, a reason and so forth.

Pursuant to embodiments of the present disclosure, a connection may be established between the metafile block that is operable to store the extracted metafile associated with the proof of occurrence and at least one of the smart contract block and the validation block. In other words, the metafile block that stores the data and credentials extracted from the proof of occurrence may be associated with the smart contract block and/or the validation block.

The server arrangement activates the ledger clock for the smart contract, wherein the ledger clock is configured to defer the execution of the smart contract to the next cycle of the ledger clock in response to absence of activation of the validation indicator in the smart contract. The term “ledger clock” refers to an entity associated with a block in the blockchain that defines a timestamp for the execution thereof. Specifically, the ledger clock can be referred to a clock associated with the blockchain platform, wherein the clock administers the time of execution of the block in the blockchain. The ledger clock of a block is triggered once the block is added to the blockchain.

Furthermore, the ledger clock has ledger clock cycles associated therewith, wherein the ledger clock administers an attempt at the execution of the smart contract at the completion of each ledger clock cycle. Specifically, at the completion of every ledger clock cycle, the activation of the validation indicator is checked. In an instance, when the validation indicator has been not activated, the ledger clock is configured to defer the execution of the smart contract to a next cycle of the ledger clock. In other words, the ledger clock is configured to defer the execution of the smart contract to the next cycle of the ledger clock in response to absence of activation of the validation indicator in the smart contract. In another instance, when the validation indicator has been activated, the ledger clock is configured to execute the smart contract at the completion of a ledger clock cycle. As discussed previously, the validation indicator is activated upon satisfaction of the validation condition.

The server arrangement enables the second party to retrieve the digital cryptocurrency, in response to execution of the smart contract at a completion of the ledger clock cycle, wherein the execution of the smart contract is based on activation of the validation indicator. Furthermore, the second party is enabled to retrieve, using the second client device, the digital cryptocurrency. As mentioned previously, the server arrangement stores the digital cryptocurrency and/or details associated therewith. Consequently, in response to the execution of the smart contract, the digital cryptocurrency and/or details associated with the digital cryptocurrency are retrieved from the distributed file system using the access identifier.

In an embodiment, the capital inheritance system may facilitate the transfer of the digital cryptocurrency from a digital wallet of the first party to a digital wallet of the second party. In another embodiment, the capital inheritance system may facilitate the transfer of details associated with a digital wallet storing the digital cryptocurrency for access thereof. In such case, the capital inheritance system may provide the second party with at least one of: a link for the digital wallet, a username of the digital wallet, a security pin of the digital wallet, a security password of the digital wallet, and so forth. In yet another embodiment, the first party may employ the capital inheritance system to transfer the ownership of a digital wallet of the first party, to the second party. Furthermore, the server arrangement may be configured to store details associated with the digital cryptocurrency obtained directly or indirectly from the first party, in a storage system such as a relational database, a distributed file system, and so forth.

More optionally, the server arrangement may store the plurality of information such as the details associated with the digital cryptocurrency, the validation condition, the identification information related to the second party and/or the identification details related to the first party in a distributed file system. The distributed file system provides a protocol for storing and exchanging documents for peer-to-peer transfers. Furthermore, the plurality of information may be stored at various peer pertaining to various public records of the distributed file system. The peer records are not dependent on each other; this ensures that the distributed file system has no failures due to non-functionality of any of the peer records. Once stored, the content of the plurality of information cannot be changed. This makes the distributed file system secure. An example of the distributed file system is InterPlanetary File System (IPFS).

Optionally, the server arrangement further provides an intimation message to the second party upon not receiving the proof of occurrence for satisfaction of the validation condition prior to completion of a cycle of the ledger clock. Specifically, the smart contract is executed only upon receiving proof of occurrence relating to the validation condition. However, upon not receiving the proof of occurrence relating to the validation condition, the intimation message is sent to the second party. Optionally, the intimation message may be provided to the second party via an electronic mail. More optionally, the intimation message may be presented on the graphical user interface of the second client device (or the second server) of the second party while operating the capital inheritance system.

Optionally, the server arrangement enables the first party to modify at least one of: the validation condition, the identification information related to the second party, the details associated with the digital cryptocurrency, and the periodic interval of time, via the first client device of the first party. Specifically, the server arrangement is configured to enable the first party, via the graphical user interface of the first client device, communicably coupled to the server arrangement, to modify the validation condition, the identification information related to the second party, the details associated with the digital cryptocurrency and/or the periodic intervals of time. In an example, the first party may change the validation condition from ‘obtaining a graduation degree’ to ‘obtaining a graduation degree in law’. In another example, the first part may add a new second party to the capital inheritance system.

Furthermore, optionally, upon receiving a modification, the server arrangement is configured to
associate a termination condition pertaining to the smart contract; and
generate a secondary smart contract for transfer of digital cryptocurrency based on the modification.

Specifically, upon receiving a modification request from the first party, the server arrangement associates a termination condition with the smart contract block associated with the foregoing information. Consequently, a termination block may be added in communication with the smart contract block, in the blockchain, associated with the foregoing information. Typically, the termination block comprises information pertaining to the termination or discontinuation of the smart contract associated with the foregoing information. In an example, the termination block may comprise ‘smart contract modified’. Furthermore, the server arrangement may generate the secondary smart contract. In such case, the secondary smart contract defines a plurality of modified terms and conditions pertaining to a new consensus based upon the modification done by the first party. In an example, the first party may modify the validation condition. Consequently, the secondary smart contract may define a plurality of modified terms and conditions pertaining to a new consensus based upon the modification in the validation condition.

Moreover, optionally, the smart contract is executed after the activation of the validation indicator. It will be appreciated that upon the upload of the proof of occurrence, the proof of occurrence is authenticated. Furthermore, upon obtaining the authenticated proof of occurrence, the server arrangement validates the fulfillment of the validation condition, thereby adding the validation block to the blockchain platform. Moreover, the addition of the validation block activates the validation indicator incorporated in the smart contract block. Consequently, the activation of the validation indicator enables the execution the smart contract. Typically, the capital inheritance system attempts to execute the smart contract upon the completion of the ledger clock cycle. However, inactivation of the prompt function prevents the execution of the smart contract. Furthermore, upon the addition of the validation block, the validation indicator is activated thereby, executing the smart contract at the subsequent completion of the ledger clock cycle.

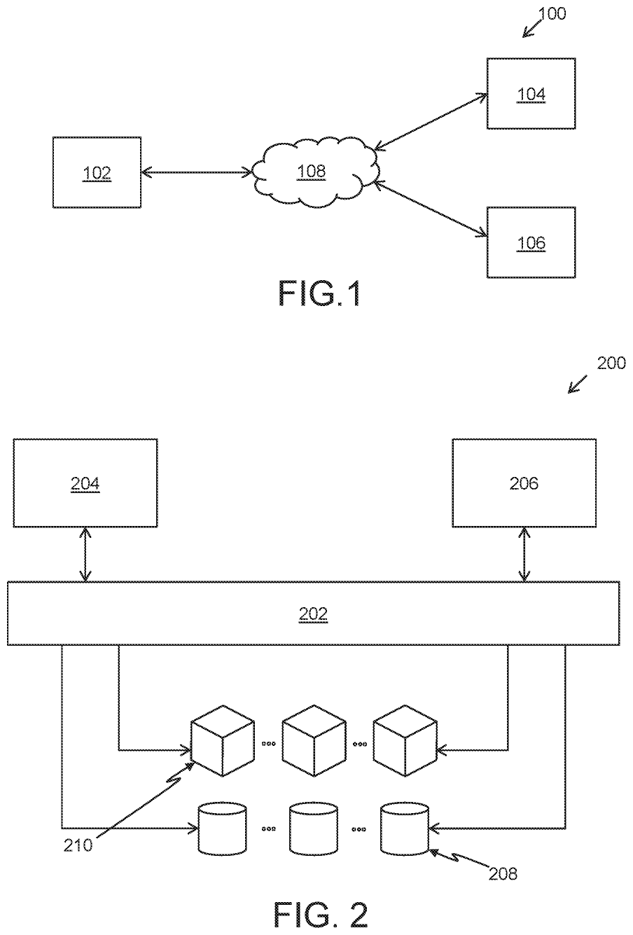

For illustration purposes only, there will now be considered an example network environment, wherein a system for transferring digital cryptocurrency from a first party to a second party can be implemented pursuant to embodiments of the present disclosure. One such network environment has been illustrated in conjunction with FIG. 1 as explained in more detail below.

The network environment includes a first client device and a second client device, a server arrangement of the system, a database arrangement of the system, and one or more data communication networks. The server arrangement, comprising one or more processors, is communicably coupled via the one or more data communication networks with the first client device and the second client device. Optionally, the network environment also includes a plurality of database servers communicably coupled via the one or more data communication networks with the one or more processors of the server arrangement.

It will be appreciated that it is not necessary for the one or more processors of the server arrangement to be coupled in communication with all the client devices simultaneously at all times. The one or more processors of the server arrangement are configured to execute machine readable instructions that cause the server arrangement to perform operations, for example, as illustrated with respect to the aforementioned aspect.

Moreover, the present description also relates to the method as described above. The various embodiments and variants disclosed above apply mutatis mutandis to the method.

Optionally, the validation condition is satisfied upon receiving proof of occurrence relating to the validation condition.

Optionally, the method comprises providing an intimation message to the second party upon not receiving the proof of occurrence for satisfaction of the validation condition prior to completion of a cycle of the ledger clock.

Optionally, the method comprises authenticating the proof of occurrence relating to the validation condition.

Optionally, the method comprises storing a validation block on the blockchain upon successful authentication of the proof of occurrence relating to the validation condition.

Optionally, the method comprises storing a metafile block on the blockchain, wherein the metafile block comprises information extracted from the proof of occurrence.

Optionally, the method comprises enabling the first party to modify at least one of: the validation condition, the identification information related to the second party, and the details associated with the digital cryptocurrency, via the first client device.

Optionally, the method comprises enabling the first party to modify at least one of: the validation condition, the identification information related to the second party, the details associated with the digital cryptocurrency, and the periodic interval of time, via the first client device.

Optionally, upon receiving a modification, the method comprises:
associating a termination condition pertaining to the smart contract; and
generating a secondary smart contract for transfer of digital currency based on the modification.

Optionally, the smart contract comprises at least one of: a contract for the undertaking of the digital cryptocurrency, an identification information related to the first party, an identification information related to the second party, and a proof of witness.

### DETAILED DESCRIPTION OF THE DRAWINGS

Referring now to the drawings, particularly by their reference numbers, FIG. 1 is a schematic illustration of a network environment 100, wherein a capital inheritance system for facilitating a transfer of digital cryptocurrency from a first party to a second party is implemented, pursuant to an embodiment of the present disclosure.

The network environment 100 comprises a server arrangement 102, a first client device 104 of the first party and a second client device 106 of the second party. The server arrangement 102 is communicably coupled via one or more communication networks (depicted as a communication network 108) with the first client device 104 of the first party and the second client device 106 of the second party.

FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of server arrangements, client devices, and communication networks. A person skilled in the art will recognize many variations, alternatives, and modifications of embodiments of the present disclosure.

Referring to FIG. 2 illustrated is a schematic illustration of a high-level architecture of a network environment 200 in which a capital inheritance system for facilitating a transfer of digital cryptocurrency from a first party to a second party is implemented, pursuant to a specific embodiment of the present disclosure.

The network environment 200 comprises a server arrangement 202 including one or more processors, a first client device 204 of the first party and a second client device 206 of the second party. The server arrangement 202 is communicably coupled via one or more communication networks (not shown) with the first client device 204 of the first party and the second client device 206 of the second party.

Moreover, the network environment 200 comprises a distributed file system 208, wherein plurality of information such as the details associated with the digital cryptocurrency, the validation condition, the identification information related to the second party and/or the identification details related to the first party is stored. Furthermore, the network environment 200 comprises a blockchain platform 210, wherein the blockchain platform stores details pertaining to the transfer of the digital cryptocurrency from the first party to the second party in form of immutable block. Furthermore, the blockchain platform stores at least one of: a smart contract block, a validation block, a metafile block, and a termination block.

FIG. 2 is merely an example, which should not unduly limit the scope of the claims herein. It is to be understood that the specific designation for the network environment 200 is provided as an example and is not to be construed as limiting the network environment 200 to specific numbers, types, or arrangements of server arrangements, client devices, modules, distributed file systems and blockchain platforms. A person skilled in the art will recognize many variations, alternatives, and modifications of embodiments of the present disclosure.

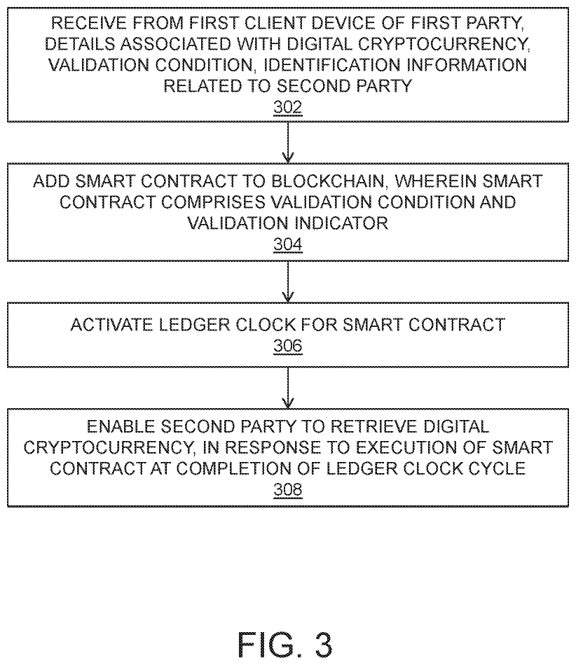

Referring to FIG. 3, illustrated is a flow chart depicting steps of a method of facilitating a transfer of digital cryptocurrency from a first party to a second party, in accordance with an embodiment of the present disclosure. The method is depicted as a collection of steps in a logical flow diagram, which represents a sequence of steps that can be implemented in hardware, software, or a combination thereof, for example as aforementioned.

The method is implemented via a system comprising a server arrangement communicably coupled via one or more communication networks with a first client device of the first party and a second client device of the second party.

At a step 302, details associated with the digital cryptocurrency, a validation condition, identification information related to the second party are received from the first client device of the first party.

At a step 304, a smart contract is added to a blockchain, wherein the smart contract comprises the validation condition and a validation indicator, and wherein activation of the validation indicator in the smart contract indicates a satisfaction of the validation condition.

At a step 306, a ledger clock is activated for the smart contract, wherein the ledger clock is configured to defer an execution of the smart contract to a next cycle of the ledger clock in response to absence of activation of the validation indicator in the smart contract.

At a step 308, the second party is enabled to retrieve the digital cryptocurrency, in response to an execution of the smart contract at a completion of a ledger clock cycle, wherein the execution of the smart contract is based on activation of the validation indicator.

The steps 302 to 308 are only illustrative and other alternatives can also be provided where one or more steps are added, one or more steps are removed, or one or more steps are provided in a different sequence without departing from the scope of the claims herein.

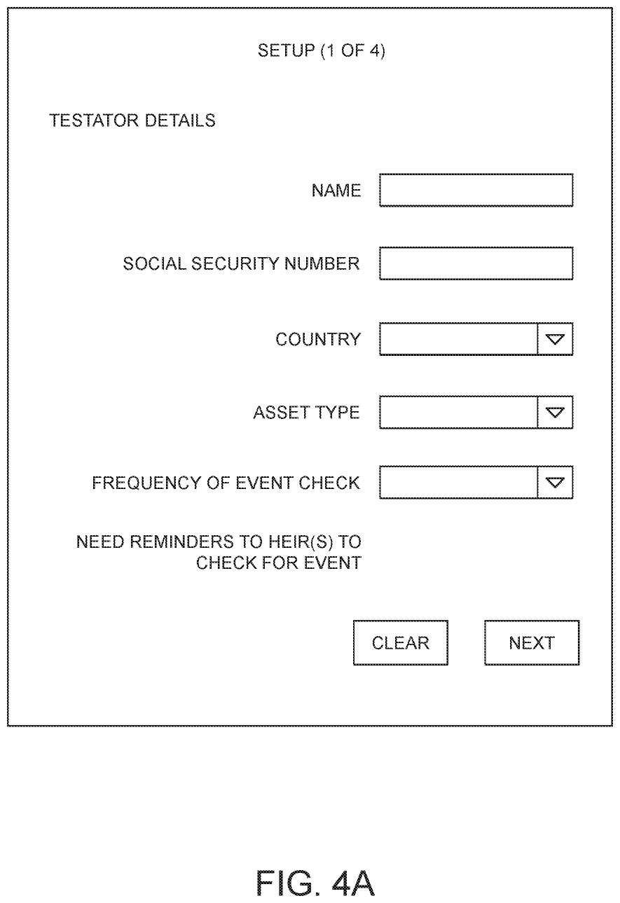

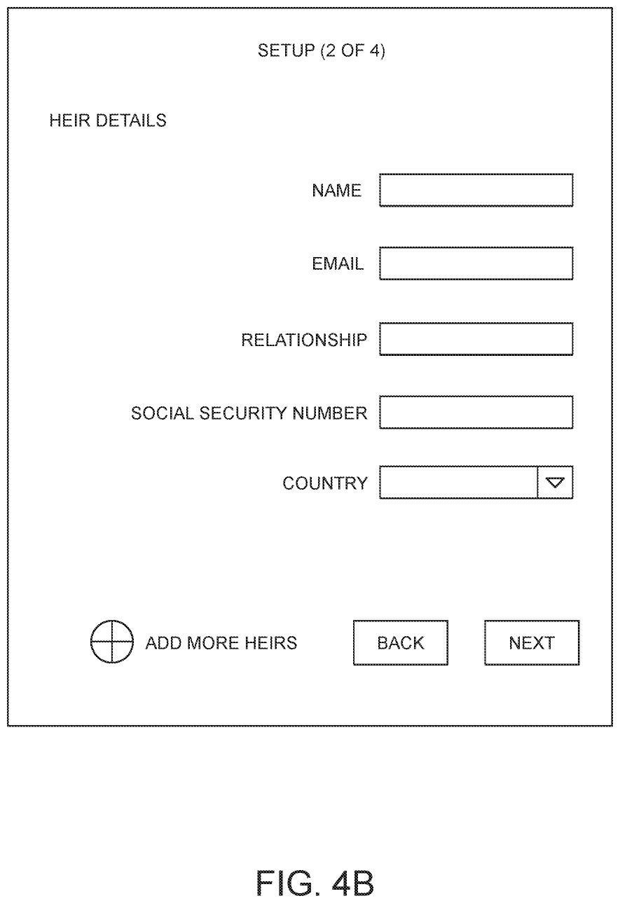

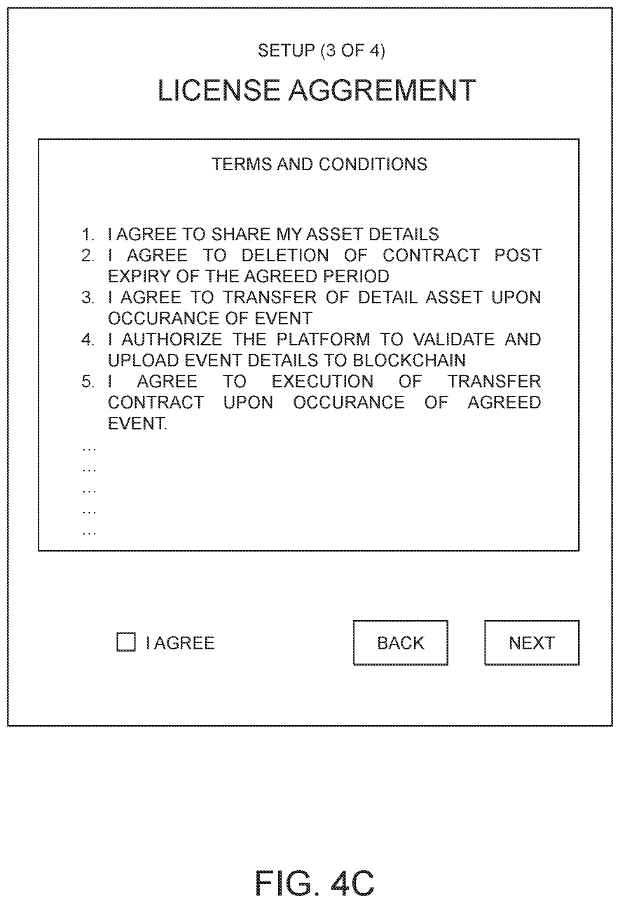

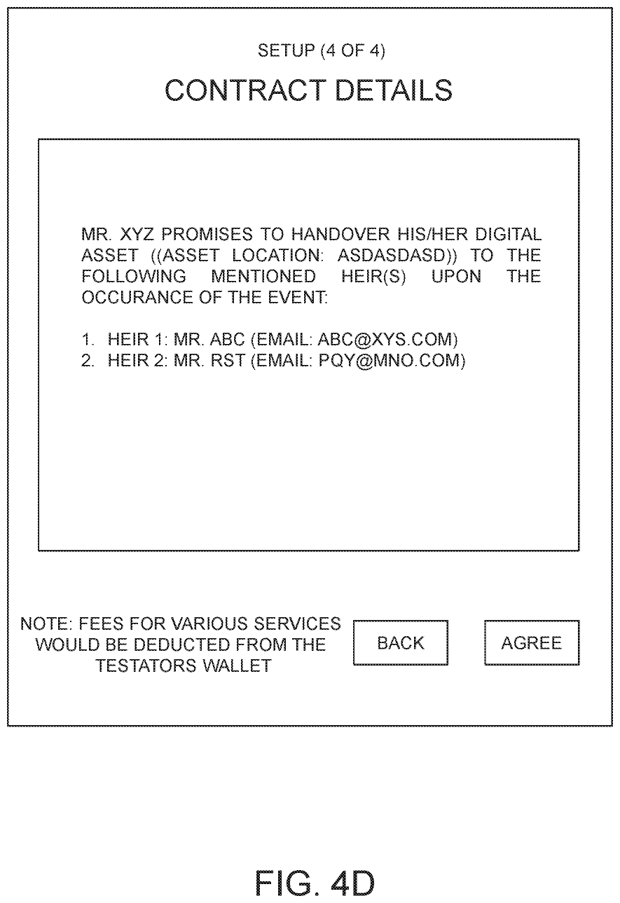

FIGS. 4A, 4B, 4C and 4D are example views of a user interface of a capital inheritance system presented on a graphical user interface of a first client device or a first server of a first party, in accordance with an embodiment of the present disclosure.

With reference to FIG. 4A, a first example view includes text boxes and/or drop-down menus that allow the first party to enter details and/or select a suitable option pertaining to an identification information related to the first party.

With reference to FIG. 4B, a second example view includes text boxes and/or drop-down menus that allow the first party to enter details and/or select a suitable option pertaining to an identification information related to the second party.

With reference to FIG. 4C, a third example view depicts an exemplary license agreement. Furthermore, the example view includes a user selectable menu that allows the first party to provide a permission to the server arrangement to facilitate the transfer of the digital cryptocurrency from the first party to the second party.

With reference to FIG. 4D, a fourth example view depicts an exemplary smart contract generated by the server arrangement. Notably, the smart contract includes a contract for the undertaking of the digital cryptocurrency, an identification information associated with the first party, and an identification information associated with the second party to facilitate the transfer of digital cryptocurrency from the first party to the second party upon the fulfilment of the validation condition.

FIGS. 4A, 4B, 4C and 4D are merely examples, which should not unduly limit the scope of the claims herein. A person skilled in the art will recognize many variations, alternatives, and modifications of embodiments of the present disclosure. For example, another example view of the graphical user interface can show and allow the first party to edit the plurality of information provided by the first party.

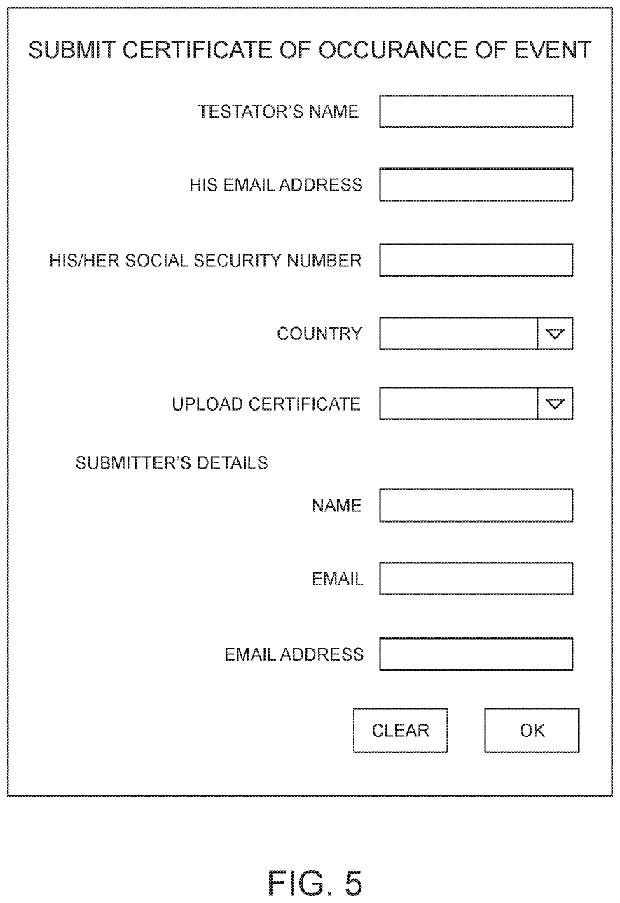

FIG. 5 is an example view of a user interface of a capital inheritance system to provide proof of occurrence related to a validation condition, in accordance with an embodiment of the present disclosure. Furthermore, a user interface to provide proof of occurrence related to a validation condition (such as, a form) includes text boxes and/or drop-down menus that allow the first party or the second party to enter details and/or select a suitable option. Moreover, the form to provide proof of occurrence related to a validation condition is presented on a graphical user interface of a first client device of a first party and/or a second client device of a second party.

FIG. 5 is merely example, which should not unduly limit the scope of the claims herein. A person skilled in the art will recognize many variations, alternatives, and modifications of embodiments of the present disclosure. For example, another example view of the graphical user interface can allow the second party to initiate a request for accessing the form to provide proof of occurrence related to a validation condition.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A capital inheritance system, when in operation, facilitates a transfer of digital cryptocurrency from a first party to a second party, the capital inheritance system comprising a server arrangement communicably coupled via one or more communication networks with a first client device of the first party and with a second client device of the second party, wherein the server arrangement:
receives, from the first client device of the first party, details associated with the digital cryptocurrency, a validation condition, identification information related to the second party;
adds a smart contract to a blockchain, wherein the smart contract comprises the validation condition and a validation indicator, and wherein activation of the validation indicator in the smart contract indicates a satisfaction of the validation condition;
activates a ledger clock for the smart contract, wherein the ledger clock is configured to defer an execution of the smart contract to a next cycle of the ledger clock in response to absence of activation of the validation indicator in the smart contract; and
enables the second party to retrieve the digital cryptocurrency, in response to an execution of the smart contract at a completion of a ledger clock cycle, wherein the execution of the smart contract is based on activation of the validation indicator.

2. The capital inheritance system of claim 1, wherein the validation condition is satisfied upon receiving proof of occurrence relating to the validation condition.

3. The capital inheritance system of claim 2, wherein the server arrangement further provides an intimation message to the second party upon not receiving the proof of occurrence for satisfaction of the validation condition prior to completion of a cycle of the ledger clock.

4. The capital inheritance system of claim 1, wherein the server arrangement authenticates the proof of occurrence relating to the validation condition.

5. The capital inheritance system of claim 4, wherein the server arrangement further stores a validation block on the blockchain upon successful authentication of the proof of occurrence relating to the validation condition.

6. The capital inheritance system of claim 1, wherein the server arrangement stores a metafile block on the blockchain,-wherein the metafile block comprises information extracted from the proof of occurrence.

7. The capital inheritance system of claim 1, wherein the server arrangement enables the first party to modify at least one of: the validation condition, the identification information related to the second party, and the details associated with the digital cryptocurrency, via the first client device.

8. The capital inheritance system of claim 7, wherein upon receiving a modification, the server arrangement:
associates a termination condition pertaining to the smart contract; and
adds a secondary smart contract to the blockchain for transfer of digital currency based on the modification.

9. The capital inheritance system of claim 1, wherein the smart contract comprises at least one of: a contract for the undertaking of the digital cryptocurrency, an identification information related to the first party, an identification information related to the second party, and a proof of witness.

10. A method of facilitating a transfer of digital cryptocurrency from a first party to a second party, wherein the method is implemented via a capital inheritance system comprising a server arrangement communicably coupled via one or more communication networks with a first client device of the first party and with a second client device of the second party, the method comprising:
receiving, from the first client device of the first party, details associated with the digital cryptocurrency, a validation condition, identification information related to the second party;
adding a smart contract to a blockchain, wherein the smart contract comprises the validation condition and a validation indicator, and wherein activation of the validation indicator in the smart contract indicates a satisfaction of the validation condition;
activating a ledger clock for the smart contract, wherein the ledger clock is configured to defer an execution of the smart contract to a next cycle of the ledger clock in response to absence of activation of the validation indicator in the smart contract; and
enabling the second party to retrieve the digital cryptocurrency, in response to an execution of the smart contract at a completion of a ledger clock cycle, wherein the execution of the smart contract is based on activation of the validation indicator.

11. The method of claim 10, wherein the validation condition is satisfied upon receiving proof of occurrence relating to the validation condition.

12. The method of claim 11, wherein the method comprises providing an intimation message to the second party upon not receiving the proof of occurrence for satisfaction of the validation condition prior to completion of a cycle of the ledger clock.

13. The method of claim 10, wherein the method comprises authenticating the proof of occurrence relating to the validation condition.

14. The method of claim 13, wherein the method further comprises storing a validation block on the blockchain upon successful authentication of the proof of occurrence relating to the validation condition.

15. The method of claim 10, wherein the method comprises storing a metafile block on the blockchain, wherein the metafile block comprises information extracted from the proof of occurrence.

16. The method of claim 10, wherein the method comprises enabling the first party to modify at least one of: the validation condition, the identification information related to the second party, and the details associated with the digital cryptocurrency, via the first client device.

17. The method of claim 16, wherein upon receiving a modification, the method comprises:
associating a termination condition pertaining to the smart contract; and
generating a secondary smart contract for transfer of digital currency based on the modification.

18. The method of claim 10, wherein the smart contract comprises at least one of: a contract for the undertaking of the digital cryptocurrency, an identification information related to the first party, an identification information related to the second party, and a proof of witness.
